(19) United States
(12) Patent Application Publication
(10) Pub. No.: US 2021/0336973 A1
(43) Pub. Date: Oct. 28, 2021

(54) METHOD AND SYSTEM FOR DETECTING MALICIOUS OR SUSPICIOUS ACTIVITY BY BASELINING HOST BEHAVIOR

(71) Applicant: CHECK POINT SOFTWARE TECHNOLOGIES LTD., Tel Aviv (IL)

(72) Inventors: Tamara LEIDERFARB, Modiin (IL); Lior Arzi, Givatayim (IL); Ilana Danan, Tel Aviv (IL)

(21) Appl. No.: 16/858,817

(22) Filed: Apr. 27, 2020

(51) Int. Cl. H04L 29/06

(52) U.S. Cl. CPC H04L 63/1416; H04L 63/145; H04L 63/1425

(57) ABSTRACT

The disclosed subject matter includes a system, which when installed in a specific host, such as an end point, or end point computer, will model its behavior over time, score new activities in real time and calculate outliers, by creating and analyzing vectors. The vectors are formed of feature values, extracted from executable processes, and the analysis includes the determining and evaluating the distance between a current vector and a cluster of vectors.

### TECHNICAL FIELD

The present disclosure relates to systems for detecting malicious content including malware.

### BACKGROUND

When looking into a computer host as an ecosystem over time, most entities behave similarly to their previous instances. This known behavior allows for the modeling of behavior at a baseline which represents “normal” host behavior.

Malware, in its different stages, needs to function similar to regular software in the host ecosystem and use the same resources and entities as regular software in order to achieve its objectives. However, the malware uses the resources in the host ecosystem differently than regular, non-malicious software.

### SUMMARY

The present disclosed subject matter, also referred to herein as the disclosure, analyzes how the same resources are used differently by regular non-malicious software and malware. For example, the present disclosed subject matter analyzes how the regular non-malicious software and malware use the same resources and entities, such as, execution, persistence, reconnaissance, data exfiltration, or other execution attributes, in different ways. As a result, a baseline is established from the behavior of the non-malicious software from which the malware is compared.

The disclosed subject matter includes a system, which when installed in a specific host, such as an end point, or end point computer, will model its behavior over time, score new activities in real time and calculate outliers, by creating and analyzing vectors. The vectors are formed of feature values, extracted from executable processes, and the analysis includes the determining and evaluating the distance between a current vector and a cluster of vectors. The behavior modeling over time, scoring new activities in real time, and calculating outliers is achieved by storing activity data for a time period, categorizing it, extracting relevant features, and calculating outliers.

The disclosed system uses a set of features and anchors. Anchors are a certain subset of features, and define what can be compared to what, while the features define the data to be compared.

Examples of features may be: Process Name, File Name, number of file read operations, number of network operations in a specific port, number of processes spawned, number of injections to other processes, parent process, directory, user ID doing the operation, file extension, file magic bytes, and the like. Each feature may be defined as an anchor. Examples of anchors include, Process Name, file extension, communication port, file name.

The comparison algorithms may vary between different anchors and the quantity of historical data. This may evolve over time. The outcome of a specific calculation relies on pre-configured thresholds, which define the “aggressiveness” of the system and the tolerance for false positives.

The risk level and confidence of the detection rely on extra data and relatively heavy calculations that are applied only to outliers, in order to increase or decrease the score and confidence, that the outlier is truly an outlier.

Embodiments of the disclosed subject matter are directed to a computer implemented method for detecting malware on a computer. The method comprises: extracting feature values from a process executing on the computer; creating a current feature value vector from the extracted feature values; selecting at least one of the feature values of the current feature value vector as at least one anchor value; and, determining whether there is a matching of the anchor values between the current feature value vector and at least one other feature value vector. The determination of the matching of the anchor values is such that: should there be a matching of the anchor values of the feature value vectors, associating the current feature value vector with a cluster of feature value vectors, and determining whether the distance of the current feature value vector to a center of the cluster renders the current feature value vector suspicious as indicative of malware; or, should there not be a matching of the anchors values of the feature value vectors, obtaining data associated with the current feature value vector, and based on the associated data, determining whether the current feature value vector is suspicious as indicative of malware.

Optionally, the computer implemented method is such that the process includes at least one of: payload processes; container/compression/installer processes; executables; rename processes; registry consumer processes; network processes; and, processes not categorized as one of payload processes, container/compression/installer processes, executables, rename processes, registry consumer processes, and network processes.

Optionally, the computer implemented method is such that the matching includes exact matches or approximate matches.

Optionally, the computer implemented method is such that the obtaining data is performed when the one or more anchor values present as a first occurrence.

Optionally, the computer implemented method is such that the data is obtained by hashing a file associated with the feature value vector for reputation information about the feature values of the feature value vector.

Optionally, the computer implemented method is such that the feature values one or more of: process ID, executable names, and, executable network parameters, including destination ports.

Optionally, the computer implemented method is such that the feature values are based on features including: Process Name, File Name, number of file read operations, number of network operations in a specific port, communication port, number of processes spawned, number of injections to other processes, parent process, directory, user ID doing the operation, file extension, and, file magic bytes.

Optionally, the computer implemented method is such that it additionally comprises: assigning a score to the distance of the current feature value vector to the center of the cluster and comparing the score against a threshold score; such that the score exceeding the threshold score renders the current feature value vector suspicious as indicative of malware.

Optionally, the computer implemented method is such that the distance of the current feature value vector to the center of the cluster includes a Euclidean distance.

Optionally, the computer implemented method is such that it additionally comprises: normalizing the extracted feature values.

Optionally, the computer implemented method is such that the creating the feature value vector from the extracted feature values includes: creating the feature value vector from the normalized extracted feature values.

Optionally, the computer implemented method is such that it additionally comprises: tagging the current feature value vector as either suspicious or benign based on whether the current feature value vector is suspicious as indicative of malware.

Optionally, the computer implemented method is such that the selected at least one of the feature values of the current feature value vector corresponds to the at least one anchor value.

Optionally, the computer implemented method is such that the selected at least one of the feature values of the current feature value vector includes a plurality of feature values, and the at least one anchor value includes a plurality of anchor values, such that, each of the feature values of the plurality of selected as an anchor value corresponds to one of the anchor values of the plurality of anchor values.

Optionally, the computer implemented method is such that the at least one other feature value vector is obtained from storage.

Embodiments of the disclosed subject matter are directed to a computer system for detecting malware on a computer. The computer system comprises: a non-transitory storage medium for storing computer components; and, a computerized processor for executing the computer components. The computer components comprise: a module for extracting feature values from a process executing on the computer; a module for creating a current feature value vector from the extracted feature values; a module for selecting at least one of the feature values of the current feature value vector as at least one anchor value; and, a module for determining whether there is a matching of the anchor values between the current feature value vector and at least one other feature value vector, such that: 1) should there be a matching of the anchor values of the feature value vectors, associating the current feature value vector with a cluster of feature value vectors, and determining whether the distance of the current feature value vector to a center of the cluster renders the current feature value vector suspicious as indicative of malware; or, 2) should there not be a matching of the anchors values of the feature value vectors, obtaining data associated with the current feature value vector, and based on the associated data, determining whether the current feature value vector is suspicious as indicative of malware.

Optionally, the computer system is such that it additionally comprises: a module for assigning a score to the distance of the current feature value vector to the center of the cluster and comparing the score against a threshold score; such that the score exceeding the threshold score renders the current feature value vector suspicious as indicative of malware.

Optionally, the computer system is such that it additionally comprises: a module for tagging the current feature value vector as either suspicious or benign based on whether the current feature value vector is suspicious as indicative of malware.

Embodiments of the disclosed subject matter are directed to a computer usable non-transitory storage medium having a computer program embodied thereon for causing a suitably programmed system to detect malware on a computer, by performing the following steps when such program is executed on the system. The steps comprise: extracting feature values from a process executing on the computer; creating a current feature value vector from the extracted feature values; selecting at least one of the feature values of the current feature value vector as at least one anchor value; and, determining whether there is a matching of the anchor values between the current feature value vector and at least one other feature value vector, such that: 1) should there be a matching of the anchor values of the feature value vectors, associating the current feature value vector with a cluster of feature value vectors, and determining whether the distance of the current feature value vector to a center of the cluster renders the current feature value vector suspicious as indicative of malware; or, 2) should there not be a matching of the anchors values of the feature value vectors, obtaining data associated with the current feature value vector, and based on the associated data, determining whether the current feature value vector is suspicious as indicative of malware.

Optionally, the computer usable non-transitory storage medium system is such that the steps additionally comprise: assigning a score to the distance of the current feature value vector to the center of the cluster and comparing the score against a threshold score; such that the score exceeding the threshold score renders the current feature value vector suspicious as indicative of malware.

This document references terms that are used consistently or interchangeably herein. These terms, including variations thereof, are as follows:

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smart phone, personal digital assistant (PDA), mobile telephone or cellular telephone).

A “server” is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

Unless otherwise defined herein, all technical and/or scientific terms used herein have the same meaning as commonly understood by one of ordinary skill in the art to which the disclosure pertains. Although methods and materials similar or equivalent to those described herein may be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

The patent or application file contains at least one drawing executed in color. Copies of this patent or patent application with color drawings will be provided by the Office upon request and payment of the necessary fee.

Some embodiments of the present disclosure are herein described, by way of example only, with reference to the accompanying drawings. With specific reference to the drawings in detail, it is stressed that the particulars shown are by way of example and for purposes of illustrative discussion of embodiments of the disclosed subject matter. In this regard, the description taken with the drawings makes apparent to those skilled in the art how embodiments of the disclosed subject matter may be practiced.

Attention is now directed to the drawings, where like reference numerals or characters indicate corresponding or like components. In the drawings:

FIG. 1A is a diagram illustrating a system environment in which an embodiment of the disclosed subject matter is deployed;

FIG. 1B is a block diagram of a system in accordance with an embodiment of the disclosed subject matter;

FIG. 2 is a flow diagram of a method in accordance with embodiments of the disclosed subject matter;

FIG. 3 is a diagram of vectors, features and anchors;

FIG. 4A is a diagram of clustering based on T-Distributed Stochastic Neighbor Embedding (TSNE); and,

FIG. 4B is a diagram of the clustering of FIG. 4A based on a malware analysis.

### DETAILED DESCRIPTION OF THE DRAWINGS

Before explaining at least one embodiment of the disclosure in detail, it is to be understood that the disclosed subject matter is not necessarily limited in its application to the details of construction and the arrangement of the components and/or methods set forth in the following description and/or illustrated in the drawings. The disclosed subject matter is capable of other embodiments or of being practiced or carried out in various ways.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more non-transitory computer readable (storage) medium(s) having computer readable program code embodied thereon.

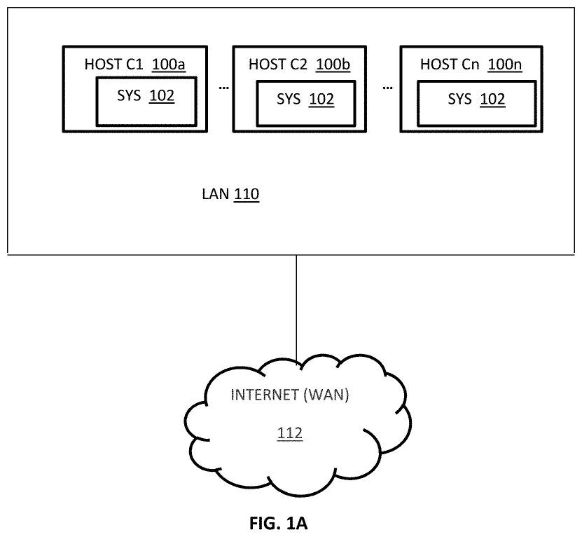

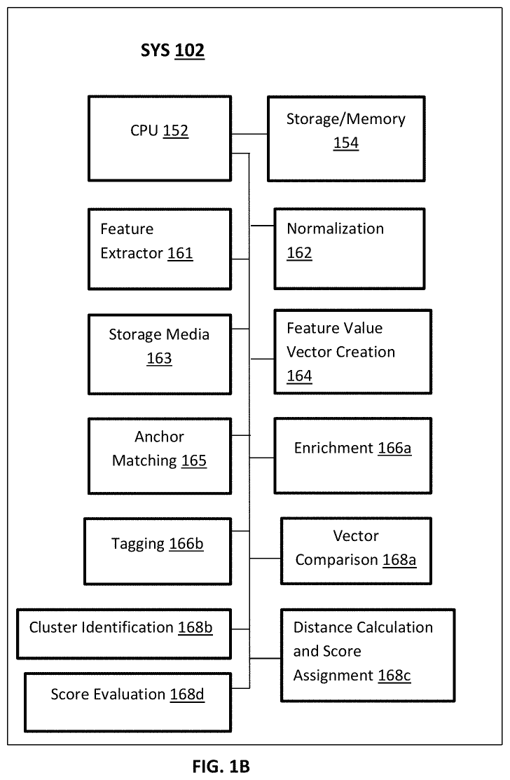

FIG. 1A shows an example environment in which the disclosed subject matter operates. Endpoint computers (C1 to Cn, “n” denoting the last member of a series) 100a, 100b, 100n, which function as hosts, include a system in accordance with the disclosed subject matter (SYS) 102 installed thereon. These endpoint computers 100a-100n are typically along a local area network (LAN) 110, such as an enterprise network. The LAN 110 links to a wide area network (WAN) 112, such as the Internet or other public network.

FIG. 1B shows an example architecture for each system (SYS) 102, installed or otherwise associated with each host (host computer) 100a, 100b, 100n. The system 102 includes multiple components in hardware and/or software. While the system 102 is shown in a host computer 100a-100n, the system 102 components do not all have to be in a host computer, and may be external to the host computer 100a-100n, and linked thereto.

The system 102 includes processors in a central processing unit (CPU) 152 linked to storage/memory 154. The CPU 152 is in turn, linked to components (computerized components or modules), such as a feature extractor 161, a normalizer 162, storage media for normalized feature values 163, feature value vector creation 164, anchor matching 165, enrichment 166a, tagging 166b, vector comparison 168a, cluster identification 168b, distance calculation and score assignment 168c, and score evaluation 168d. While these components 152, 154, 161-165, 166a, 166b and 168a-168d, are the most germane to the system 115, other components are permissible. “Linked” as used herein, includes both wired and/or wireless links, either direct or indirect, such that the components 152, 154, 161-165, 166a, 166b and 168a-168d, are in electronic and/or data communications with each other, either directly or indirectly. As used herein, a “module”, for example, includes a component for storing instructions (e.g., machine readable instructions) for performing one or more processes, and including or associated with processors, e.g., the CPU 152, for executing the instructions.

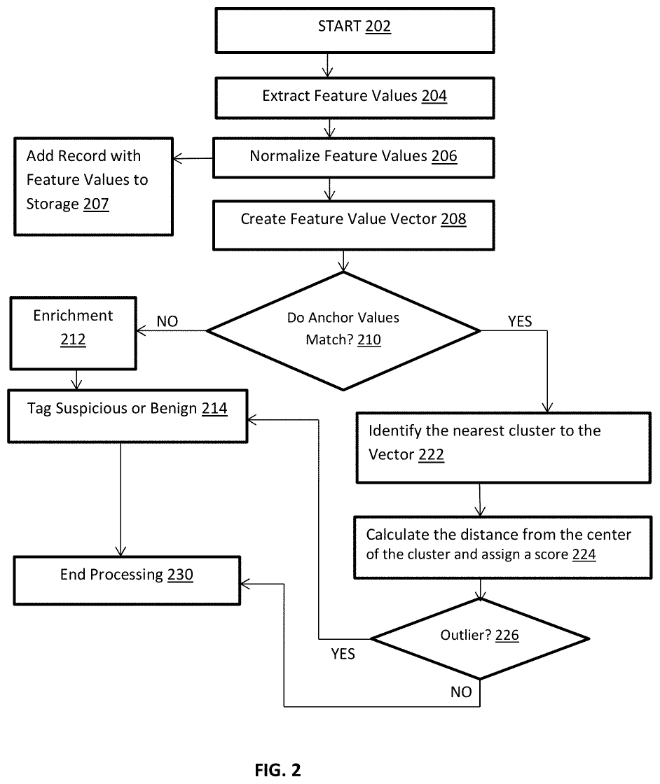

The CPU 152 is formed of one or more processors, including hardware processors, and performs methods of the disclosure, as shown in FIG. 2 and detailed below. The methods of FIG. 2 may be in the form of programs, algorithms and the like. For example, the processors of the CPU 152 may include x86 Processors from AMD (Advanced Micro Devices) and Intel, Xenon® and Pentium® processors from Intel, as well as any combinations thereof.

The storage/memory 154 stores machine-executable instructions executed by the CPU 152 for performing the methods of the disclosure (e.g., as shown in FIG. 2). The storage/memory 154, for example, also provides temporary storage for the system 102.

The feature extractor 161 operates to extract feature values from the executing process. The normalizer 162 normalizes the extracted features by setting them to a generic standard. The storage media 163 provides storage for each normalized extracted feature vector which is added as a record.

The feature value vector creator 164 obtains the normalized extracted feature values and converts them to feature value vectors.

The anchor matching module 165 performs comparison functions between anchor values in feature value vectors, to determine whether the respective one or more anchor value match. A match may be an exact match or an approximate match (e.g., a congruence, or a case-insensitive string match), as programmed into the module 165.

The enrichment module 166a functions to obtaining values, e.g., data, which is not part of the feature values from the non-matching feature value vectors. For example, enrichment may involve hashing a file to obtain reputation information about the feature values.

The tagging module 166b functions to tag the feature value vector as suspicious or benign based on an evaluation of the data obtained from the aforementioned enrichment.

The vector comparison module 168a functions to compare vectors based on matching of their non-anchor feature value. A match may be an exact match or an approximate match (e.g., a congruence, or a case-insensitive string match), as programmed into the module 168a. Based on the extent of the differences of non-anchor feature values, this module 168a determines whether the compared vector is an outlier.

The cluster identification module 168b identifies vector (e.g., feature value vector) clusters, such as a vector cluster to which a certain feature vector belongs. This vector cluster may be, for example, the vector cluster nearest in distance (e.g., Euclidean distance) to a certain feature value vector.

The distance calculation and score assignment module 168c, serves to calculate a distance, for example, a Euclidean distance, from the vector (e.g., a given vector) to the center of the vector cluster, and assigns this distance a score.

The score evaluation module 168d compares the score obtained from the module 168c, to a threshold score, which is, for example, predetermined and preprogrammed into the module 168d, to determine whether the scored vector is an outlier, and, for example, likely suspicious, representative of malware or other malicious software, virus, or the like.

Attention is now directed to FIG. 2, which shows a flow diagram detailing computer-implemented methods and sub-methods in accordance with embodiments of the disclosed subject matter. The methods and sub-methods of this flow diagram are performed by the system (SYS) 102, as installed on an endpoint computer or host 100a-100n, as shown in FIG. 1, and described above. The aforementioned methods and sub-methods are, for example, performed automatically and in real time.

The method begins at a START block 202, where a process is executed. The processes which may be executable include, for example: payload processes; container/compression/installer processes; executables; rename processes; registry consumer processes; network processes; and, processes not categorized as one of payload processes, container/compression/installer processes, executables, rename processes, registry consumer processes, and network processes.

The method moves to block 204, where feature values are extracted from the execution of the process. The extracted feature values are combined into feature value vectors by computer programs or user selections of feature values (as described for block 208 below). Examples of features include: Process Name, File Name, User Name, number of file read operations, number of network operations in a specific port, communication port, number of processes spawned, number of injections to other processes, parent process, directory, user ID performing the operation, file extension, file magic bytes, the number of occurrences of a feature value seen in a certain time period, and the like. Examples of corresponding feature values include, Outlook.exe (a process name), a.text (file name), a specific name representing a user, an integer number representing the number of occurrences of the feature value seen in a certain time period, and the like.

Each feature may be defined or otherwise selected as an anchor, with the corresponding feature value defining a corresponding anchor value. Examples of anchors include, Process Name, file extension, communication port, file name, with examples of anchor values being, Outlook.exe (a process name), Luke Skywalker (a user name), a.text (file name) and a numeral corresponding to the number of occurrences of the feature value or anchor value seen in a certain time period.

The method moves to block 206, where the extracted feature values are normalized. By normalizing, the feature values are set to a generic standard. For example, should an executable reside in a path containing a user name, the user name is replaced or removed from the executable. Different feature values are normalized in different ways. For example, a path that contains a user name can be normalized by replacing the user name with a generic string representing a user. A numeric value can be normalized by converting it into a number between 0 and 1.

As an example of normalization, the feature value vector:
Outlook.exe, “Luke Skywalker”; a.txt, 9

is normalized by replacing the user name “Luke Skywalker” with the generic string: <Generic String*>, as:
Outlook.exe, <USERNAME>, <*.txt>, 9

The method moves to block 207, where each normalized extracted feature vector is added as a record into storage.

Also from block 206, the method moves to block 208, where a feature value vector is created. The feature value vectors include, for example, values of, process ID, executable names, and executable network parameters (e.g., destination ports), with feature values also being those mentioned above. For example, from the feature value vectors, features and anchors, may be user selected, such as the feature values:
Outlook.exe, “Luke Skywalker”; a.txt, 9

where all four of the feature values define a feature value vector.

For this vector, the anchor is the process name whose value is, “Outlook.exe”, plus the user name whose value is, “Luke Skywalker”. The vector also includes the file name “a.txt”, and number of times the file is written “9”.

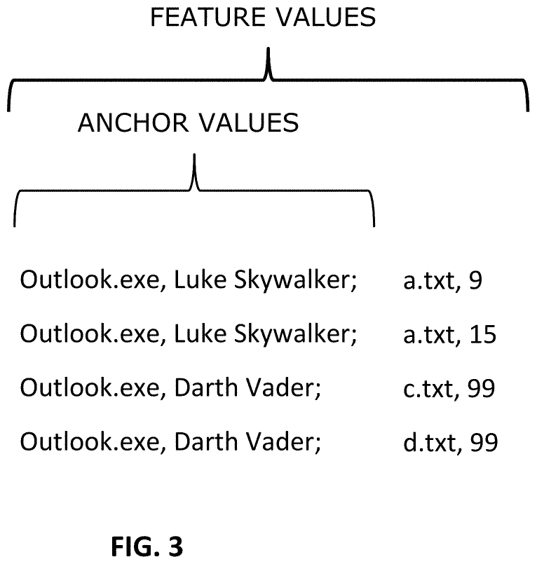

The anchor value(s) is/are the anchor portion of the feature value vector. The anchor value(s) is/are a subset of the feature values. One or more of the feature values of the feature value vector, are selected, determined or otherwise designated, automatically by computer programs, or manually, by users, as anchor values, forming the anchor portion of the feature value vector. For example, the anchor values are shown in FIG. 3, with the anchor values being indicated by the labeled bracket.

The method moves to block 210, where it is determined whether the anchor values of the Feature value vector or vector (e.g., the current or present vector, the terms “current” and “present” used interchangeably herein when describing this feature value vector or vector) match any previously recorded (and stored) anchor values of at least one other vector, in order to cluster vectors, i.e., feature value vectors. The matching involves analyzing this current or present feature value vector against one or more previous feature value vectors, by matching the anchor value(s) of the current or present feature value vector, against one or more previous feature value vectors. For example, anchor values match if they (e.g., all of the anchor values in the feature value vector) are the same in the feature value vector being compared with, or are in accordance with a congruence, programmed into the system 102. As an example, two executions which have the same process name value, e.g., Outlook.exe, could be considered as matching anchor values.

Should the anchor values of the vector (e.g., feature value vector) not match any anchor values of previously recorded vectors (e.g., feature value vectors, such as those being stored at block 207), for example, when the one or more anchor values present as a first occurrence, at block 210, the method moves to block 212. At block 212, where the feature values of the vector (e.g., feature value vector) are enriched. Enrichment is typically necessary when this is the first occurrence of the anchor value(s), and more data is needed about the feature values of the vector (e.g., feature value vector), which cannot be extracted from the execution of the computer process. Enrichment involves obtaining values, e.g., data, which are not part of the feature values. For example, enrichment may involve hashing a file to obtain reputation information about the feature values.

From block 212, the method moves to block 214, where the feature values of the feature value vector, including the anchor values, are tagged suspicious or benign. For example, a suspicious tag will be placed on the vector should an anchor value receive a bad reputation, have no reputation, be known to be malicious, have a digital signature not from a trusted authority, or have malicious indicators or other malicious characteristics, or the like. Should the anchor values be of a known good reputation, have a digital signature from a trusted authority, or the like, the vector is tagged benign. The method moves to block 230, where it ends, until the next cycle where the method is repeated.

Returning to block 210, should the anchor values of the current or present feature value vector match (either exactly or approximately, by a congruence) the anchor values of one or more previously recorded vectors (e.g., feature value vectors), the method moves to blocks 222, 224 and 226. In these blocks, a cluster for the present vector, e.g., the cluster nearest to the present vector, is determined, followed by a determination of whether the vector is an outlier, based on the distance of the vector to the center of the vector cluster, to which the vector belongs.

At block 222, the cluster of previous vectors, that have matching anchor values, nearest to the present feature value vector, is determined. This determination is based on the current (present) vector feature values including non-anchor feature values. From this determination, the closest vector cluster, to which the current (present) vector belongs, is identified. This identification is performed by algorithms, such as those for hierarchical clustering, for example, the algorithm known as “t-Distributed Stochastic Neighbor Embedding” from MathWorks® of 1 Apple Hill Drive, Natick, Mass. 01760-2098, https://www.mathworks.com/help/stats/tsne.html.

Moving to block 224, the distance from the center of the cluster to the vector (e.g., the current or present feature value vector) is calculated, and the distance is assigned a score. For example, a Euclidean distance for the vector to the center of the vector cluster is determined, and the Euclidean distance is assigned a score. The score is obtained by analyzing Euclidean distances, for example, as disclosed in, I. Salmun, et al., “On the Use of PLDA i-vector Scoring for Clustering Short Segments” Conference Paper (June 2016) DOI: 10.21437/Odyssey.2016-59 (8 Pages), this document incorporated by reference herein, and, M. Berthold, et al, “On Clustering Time Series Using Euclidean Distance and Pearson Correlation” (2016), this document incorporated by reference herein.

The method then moves to block 226, where the score for the vector is compared to a threshold score, indicative of an outlier with respect to a cluster. Should the vector score exceed the threshold score, the method moves to block 214, where the vector is tagged suspicious, and then to block 230, where the method ends. Alternately, should the method score not exceed the threshold score, the method moves to block 230 where the method ends.

The method of blocks 202 to 230 may be repeated for as long as desired, for example, depending on the number of feature value vectors created and to be analyzed.

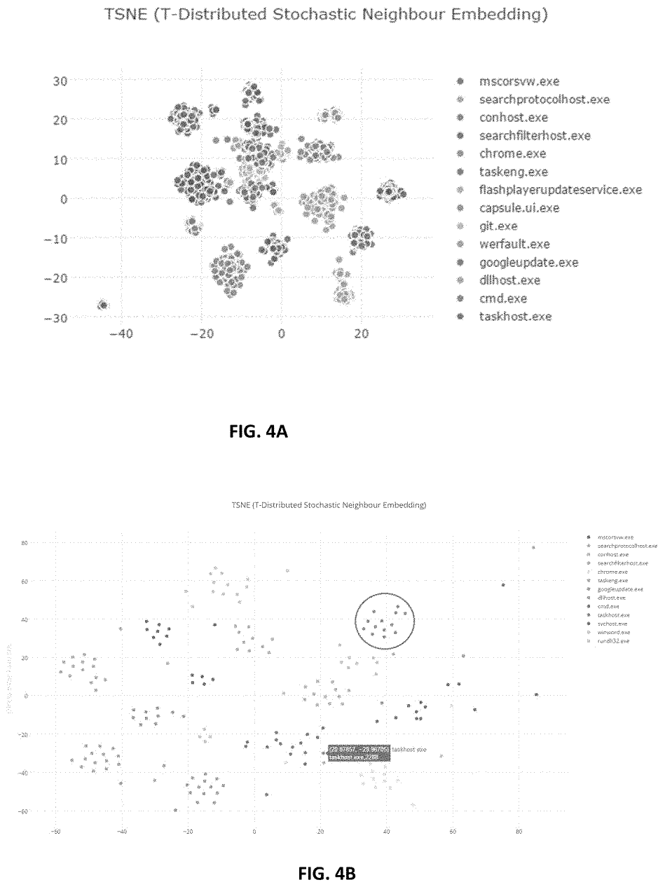

FIG. 4A is a diagram showing various vector clusters based on similarity (matching) of the anchors (e.g., anchor values) of feature value vectors. The anchors, formed of anchor values, are listed on the right side of the figure.

FIG. 4B shows the diagram of FIG. 4A showing the relationship of a vector cluster (circled) to an outlier vector (e.g., feature value vector) for that cluster, indicated by “taskhost.exe 2288”.

Here, the distance score of the outlier vector “taskhost.exe 2288” exceeds a threshold score, such that the outlier vector is tagged as suspicious. By being tagged as suspicious, this outlier vector may be indicative of malware.

While the disclosed subject matter has been shown and described on endpoint computers 100a-100n, the disclosed subject matter is suitable for operating on other computers, including servers and the like, as detailed above.

The implementation of the method and/or system of embodiments of the disclosure can involve performing or completing selected tasks manually, automatically, or a combination thereof. Moreover, according to actual instrumentation and equipment of embodiments of the method and/or system of the disclosed subject matter, several selected tasks could be implemented by hardware, by software or by firmware or by a combination thereof using an operating system.

For example, hardware for performing selected tasks according to embodiments of the disclosure could be implemented as a chip or a circuit. As software, selected tasks according to embodiments of the disclosed subject matter could be implemented as a plurality of software instructions being executed by a computer using any suitable operating system. In an exemplary embodiment of the disclosure, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present disclosure. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

The above-described methods including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The methods and systems, including components thereof, herein have been described with exemplary reference to specific hardware and software. The processes methods have been described as exemplary, whereby specific steps and their order can be omitted and/or changed by persons of ordinary skill in the art to reduce these embodiments to practice without undue experimentation. The methods and systems have been described in a manner sufficient to enable persons of ordinary skill in the art to readily adapt other hardware and software as may be needed to reduce any of the embodiments to practice without undue experimentation and using conventional techniques.

Although the disclosed subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A computer implemented method for detecting malware on a computer comprising:
extracting feature values from a process executing on the computer;
creating a current feature value vector from the extracted feature values;
selecting at least one of the feature values of the current feature value vector as at least one anchor value; and,
determining whether there is a matching of the anchor values between the current feature value vector and at least one other feature value vector, such that:
1) should there be a matching of the anchor values of the feature value vectors, associating the current feature value vector with a cluster of feature value vectors, and determining whether the distance of the current feature value vector to a center of the cluster renders the current feature value vector suspicious as indicative of malware; or,
2) should there not be a matching of the anchors values of the feature value vectors, obtaining data associated with the current feature value vector, and based on the associated data, determining whether the current feature value vector is suspicious as indicative of malware.

2. The method of claim 1, wherein the process includes at least one of: payload processes;
container/compression/installer processes; executables; rename processes; registry consumer processes; network processes; and, processes not categorized as one of payload processes, container/compression/installer processes, executables, rename processes, registry consumer processes, and network processes.

3. The method of claim 1, wherein the matching includes exact matches or approximate matches.

4. The method of claim 1, wherein the obtaining data is performed when the one or more anchor values present as a first occurrence.

5. The method of claim 4, wherein the data is obtained by hashing a file associated with the feature value vector for reputation information about the feature values of the feature value vector.

6. The method of claim 1, wherein the feature values one or more of: process ID, executable names, and, executable network parameters, including destination ports.

7. The method of claim 7, wherein the feature values are based on features including: Process Name, File Name, number of file read operations, number of network operations in a specific port, communication port, number of processes spawned, number of injections to other processes, parent process, directory, user ID doing the operation, file extension, and, file magic bytes.

8. The method of claim 1, additionally comprising: assigning a score to the distance of the current feature value vector to the center of the cluster and comparing the score against a threshold score; such that the score exceeding the threshold score renders the current feature value vector suspicious as indicative of malware.

9. The method of claim 8, wherein the distance of the current feature value vector to the center of the cluster includes a Euclidean distance.

10. The method of claim 1, additionally comprising: normalizing the extracted feature values.

11. The method of claim 10, wherein the creating the feature value vector from the extracted feature values includes: creating the feature value vector from the normalized extracted feature values.

12. The method of claim 1, additionally comprising: tagging the current feature value vector as either suspicious or benign based on whether the current feature value vector is suspicious as indicative of malware.

13. The method of claim 1, wherein the selected at least one of the feature values of the current feature value vector corresponds to the at least one anchor value.

14. The method of claim 13, wherein the selected at least one of the feature values of the current feature value vector includes a plurality of feature values, and the at least one anchor value includes a plurality of anchor values, such that, each of the feature values of the plurality of selected as an anchor value corresponds to one of the anchor values of the plurality of anchor values.

15. The method of claim 1, wherein the at least one other feature value vector is obtained from storage.

16. A computer system for detecting malware on a computer, comprising:
a non-transitory storage medium for storing computer components; and,
a computerized processor for executing the computer components comprising:
a module for extracting feature values from a process executing on the computer;
a module for creating a current feature value vector from the extracted feature values;
a module for selecting at least one of the feature values of the current feature value vector as at least one anchor value; and,
a module for determining whether there is a matching of the anchor values between the current feature value vector and at least one other feature value vector, such that:
1) should there be a matching of the anchor values of the feature value vectors, associating the current feature value vector with a cluster of feature value vectors, and determining whether the distance of the current feature value vector to a center of the cluster renders the current feature value vector suspicious as indicative of malware; or,
2) should there not be a matching of the anchors values of the feature value vectors, obtaining data associated with the current feature value vector, and based on the associated data, determining whether the current feature value vector is suspicious as indicative of malware.

17. The computer system of claim 16, additionally comprising:
a module for assigning a score to the distance of the current feature value vector to the center of the cluster and comparing the score against a threshold score; such that the score exceeding the threshold score renders the current feature value vector suspicious as indicative of malware.

18. The computer system of claim 16, additionally comprising: a module for tagging the current feature value vector as either suspicious or benign based on whether the current feature value vector is suspicious as indicative of malware.

19. A computer usable non-transitory storage medium having a computer program embodied thereon for causing a suitably programmed system to detect malware on a computer, by performing the following steps when such program is executed on the system, the steps comprising:
extracting feature values from a process executing on the computer;
creating a current feature value vector from the extracted feature values;
selecting at least one of the feature values of the current feature value vector as at least one anchor value; and, determining whether there is a matching of the anchor values between the current feature value vector and at least one other feature value vector, such that:
1) should there be a matching of the anchor values of the feature value vectors, associating the current feature value vector with a cluster of feature value vectors, and determining whether the distance of the current feature value vector to a center of the cluster renders the current feature value vector suspicious as indicative of malware; or,
2) should there not be a matching of the anchors values of the feature value vectors, obtaining data associated with the current feature value vector, and based on the associated data, determining whether the current feature value vector is suspicious as indicative of malware.

20. The computer usable non-transitory storage medium system of claim 19, wherein the steps additionally comprise:
assigning a score to the distance of the current feature value vector to the center of the cluster and comparing the score against a threshold score; such that the score exceeding the threshold score renders the current feature value vector suspicious as indicative of malware.
